(19) United States
(12) Patent Application Publication
(10) Pub. No.: US 2025/0329829 A1
(43) Pub. Date: Oct. 23, 2025

(54) Method for Producing an Electrochemical Solid-State Energy Storage Cell, and Solid-State Energy Storage Cell

(71) Applicant: Bayerische Motoren Werke Aktiengesellschaft, Muenchen (DE)

(72) Inventor: Christoph PILLER, Herrsching (DE)

(21) Appl. No.: 18/861,776

(22) PCT Filed: Apr. 5, 2023
(86) PCT No.: PCT/EP2023/058958

§ 371 Date: Oct. 30, 2024

(30) Foreign Application Priority Data
May 6, 2022 (DE) 10 2022 111 364.7

(51) Int. Cl. H01M 50/107; H01M 10/04

(52) U.S. Cl. CPC H01M 50/107; H01M 10/0431

(57) ABSTRACT

Methods for producing an electrochemical solid-state energy storage cell are provided, the method comprising introducing an energy storage unit into a sleeve, the energy storage unit comprising solid, electrochemically active layers; and reducing a circumference of the sleeve so as to compress the energy storage unit. Electrochemical solid-state energy storage cells produced using the methods herein are further provided.

### BACKGROUND AND SUMMARY

The present disclosure relates to a method for producing an electrochemical solid-state energy storage cell, and to an associated electrochemical solid-state energy storage cell.

Energy storage cells are typically used in mobile devices, such as motor vehicles for example, in order to supply these devices with electrical energy. Known energy storage cells often contain liquid electrolytes. However, energy storage cells which are intended to be formed exclusively with solid materials are currently also being developed. Stacked electrodes and separators which are connected in the form of individual plates to form a stack are used for this purpose in current manifestations. In order to produce such an energy storage cell, it is typically necessary to apply very high pressures to such a stack in order to ensure a very tight connection between the interfaces of the individual layers. It has been found that such high pressures can be realized only with great difficulty.

One object of the present disclosure is therefore to provide a method for producing an electrochemical solid-state energy storage cell which has an alternative or better design, for example is easier to apply, compared to known designs. A further object of the present disclosure is to provide an associated solid-state energy storage cell. According to the present disclosure, these objects are achieved by a method and a solid-state energy storage cell. Advantageous refinements are further provided in the present disclosure, for example.

The present disclosure relates to a method for producing an electrochemical solid-state energy storage cell, wherein the method comprises the following steps:
providing an energy storage unit which has solid electrochemically active layers,
introducing the energy storage unit into a sleeve, and
reducing a circumference of the sleeve so as to compress the energy storage unit.

By such a method, the sleeve can be used to exert a pressure onto the energy storage unit in a simple manner.

In comparison to known designs, which require external machines for exerting a pressure, a substantially simpler and more practical design can be achieved by using the abovementioned sleeve with the mentioned reduction in circumference.

The energy storage unit is typically that element which stores electrical energy in the finished solid-state energy storage cell. The solid electrochemically active layers typically form the electrochemically active part in the finished energy storage cell, so that electrical energy can be stored. In particular, the energy storage unit can be electrically charged and discharged. The sleeve surrounds this energy storage unit at least partially. In particular, the sleeve can surround the energy storage unit along a circumference. The sleeve can be designed in different ways for reducing a circumference, typical designs being discussed further below.

In particular, the energy storage unit can be cylindrical. This allows radially uniform compression of the energy storage unit by the sleeve, which can have, in particular, an at least substantially annular cross section.

In particular, the sleeve can have an entirely or at least predominantly circular cross section before the energy storage unit is introduced. As a result, the sleeve can correspond, in particular, particularly well to a cylindrical cross section of the energy storage unit. Instead of a circular cross section, an annular cross section may also be mentioned. The circular, cylindrical or annular cross sections are typically retained as the circumference is reduced and typically in the finished solid-state energy storage cell too. This allows a simple procedure, wherein a uniform pressure can be exerted onto the energy storage unit due to a reduction in circumference of the sleeve.

The energy storage unit can be, in particular, radially compressed. This can take place, in particular, along an axial extent of the energy storage unit in a uniform or at least substantially uniform manner.

According to one embodiment, the layers are spiral in cross section. According to an alternative embodiment, the layers are circular in cross section. In the case of a spiral design, the layers can be wound, in particular, continuously from the inside to the outside. In the case of a circular design, in particular a plurality of in each case inherently closed layers can be placed one on the other, as a result of which an increase in radial size is likewise achieved.

According to one embodiment, a projection or a plurality of projections is/are formed in the sleeve, and the circumference can be reduced, in particular, by compressing a projection or a plurality of projections.

The projection or the projections can project, in particular, radially outward. This allows the projections to be easily grasped and compressed. In particular, the projection or the projections can be compressed along the circumference. This allows a particularly simple reduction in circumference.

The sleeve can be formed, in particular, entirely or partially from a plastically deformable material. This leads, in particular, to a reduction in circumference, in particular including a change in the projections, being maintained and not being reversed again due to elasticity. The desired pressure is exerted in this way.

According to one embodiment, the sleeve is provided with an axially extending interruption, wherein a first free end and a second free end are situated opposite each other at the axially extending interruption. The circumference can be reduced, in particular, by fastening the first free end and the second free end to each other. A reduction in circumference can likewise be achieved in a simple and practical manner in this way, wherein the interruption can typically be considered part of the circumference in an initial state. Since the two free ends are fastened to each other, the circumference is therefore reduced overall.

In particular, an overlap between the first free end and the second free end can be created before the fastening operation. In this state, the two free ends can be fastened to each other. A yet further reduction in circumference can be achieved in this way. As an alternative, the two free ends can also be fastened to each other in the same radial position.

In particular, the fastening can be created by welding. In particular, the two free ends can be connected to each other by welding. This has proven to be a practical way of fastening. However, other ways are also possible.

According to one embodiment, the sleeve is formed entirely or partially from an elastic material. An inwardly directed force can advantageously be produced by such an elastic material. In particular, the elastic material can exert an inwardly directed force due to the elasticity after the reduction in circumference.

According to one embodiment, the energy storage unit has a solid core around which the layers are wound. Such a solid core can define an interior of the energy storage unit and form a base for winding-on or otherwise applying the abovementioned layers. In addition, the solid core can serve as a counterpiece when an inwardly directed force is exerted. The solid core can be formed, in particular, from a non-deformable material.

The present disclosure also relates to an electrochemical solid-state energy storage cell which has been produced using a method described herein. With regard to the method, use may be made of all embodiments described herein. The abovementioned advantages can be achieved.

In particular, the electrochemically active layers may be electrodes and separators. Electrodes are typically connected to external energy-supplying and/or energy-consuming units, so that the electrochemical solid-state energy storage cell can be charged and energy can be output for appropriate use. Separators typically separate the electrodes from each other.

The sleeve can form, in particular, a cell sleeve in the finished energy storage cell. Therefore, it is not necessary to additionally apply a sleeve. Instead, the sleeve used within the scope of the described method for applying a force in any case can also remain as a cell sleeve in the finished energy storage cell. The sleeve can provide, in particular, a protective function for the energy storage cell.

In particular, according to one embodiment, a sleeve can be designed as a structure which permits changes in the circumference in a subregion for compensating for a change in volume. In order to achieve the desired pretension during production, this subregion can first be pretensioned after an energy storage unit has been introduced, this energy storage unit being an electrode stack or electrode winding (jelly roll) for example. The pretensioning is performed, for example, by plastic deformation or a welded connection, which is made under pretension. In an alternative embodiment, the entire cell casing is manufactured from a material which exhibits corresponding extension under the required pressures. In the production process, the energy storage unit can be wound into the sleeve material and an overlap closure can be formed under compression. An energy storage unit typically has a core hole in which a winding mandrel or core can be located. In order to prevent this core hole from collapsing under the pressure of the system, an energy storage unit which is wound onto a sleeve, which remains in the energy storage unit, can be used in particular. Since liquid electrolytes are not typically used in the present embodiments, cover assemblies can typically be dispensed with. Sealing off of the system from water can be left to the module or storage device level.

The present disclosure will be explained in more detail below with reference to the appended figures.

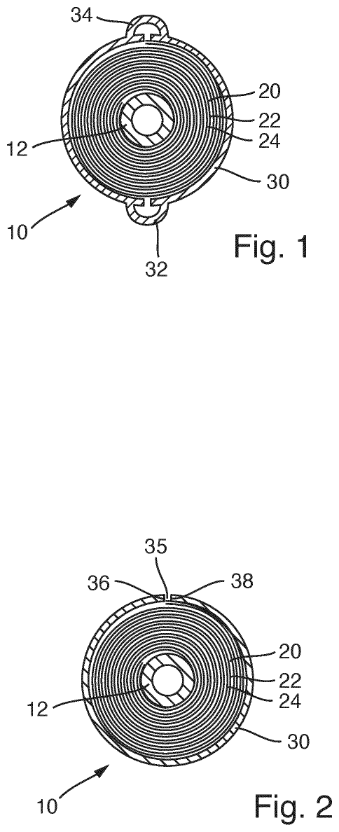

FIG. 1: shows a production state of a solid-state energy storage cell according to a first exemplary embodiment, and

FIG. 2: shows a production state of a solid-state energy storage cell according to a second exemplary embodiment.

### DETAILED DESCRIPTION OF THE DRAWINGS

FIG. 1 shows an electrochemical solid-state energy storage cell 10 according to a first exemplary embodiment in a production state. Here, a core 12 which consists of a solid material is arranged on the inside. A cylindrical energy storage unit 20, which is made up of spirally wound layers 22, 24, is located radially on the outside of the core. Here, a first layer 22 contains electrodes and a second layer 24 contains a separator. It should be understood that this is only a purely schematic illustration.

A sleeve 30 is located radially on the outside of the energy storage unit 20. In the present case, this sleeve is formed from a plastically deformable material and has a first projection 32 and a second projection 34 which each protrude outward. The sleeve 30 is positioned around the energy storage unit 20, so that the sleeve 30 rests at least substantially along the circumference of the energy storage unit 20. The two projections 32, 34 are then compressed along the circumference, so that the circumference of the sleeve 30 is reduced overall. Owing to this reduction in circumference, a radially inwardly directed force is exerted onto the energy storage unit 20, this serving to produce or improve the electrochemical properties. On account of the abovementioned plastically deformable properties of the sleeve 30, this force is retained in the finished state too. The sleeve 30 can therefore also be used as a cell sleeve for the finished energy storage cell 10.

FIG. 2 shows a solid-state energy storage cell 10 according to a second exemplary embodiment in a production state. In contrast to the first exemplary embodiment, the sleeve 30 is formed from an elastically deformable material and has no projections here, but rather has an interruption 35 at which a first free end 36 and a second free end 38 are situated opposite each other. The entire circumference of the sleeve 30 including the interruption 35 is therefore larger than a sleeve 30 composed of continuous material. The free ends 36, 38 can then be fastened to each other, wherein an overlap can also be used. The entire circumference of the sleeve 30 is therefore reduced, as a result of which a radially inwardly directed force is once again exerted onto the energy storage unit 20. The energy storage unit 20 is also compressed in this way. Owing to the elastically deformable property of the sleeve 30, a balance is ultimately established between outwardly and inwardly directed pressures, this leading to compression of the energy storage unit 20.

In comparison to known embodiments, which require external machines for exerting a pressure, a substantially simpler procedure is achieved by the described embodiments.

### List of Reference Signs

10 Solid-state energy storage cell
12 Core
20 Energy storage unit
22 First layer
24 Second layer
30 Sleeve
32 First projection
34 Second projection
35 Interruption
36 First free end
38 Second free end

1-15. (canceled)

16. A method for producing an electrochemical solid state energy storage cell, wherein the method comprises:
introducing an energy storage unit into a sleeve, the energy storage unit comprising solid, electrochemically active layers; and
reducing a circumference of the sleeve so as to compress the energy storage unit.

17. The method according to claim 16, wherein the energy storage unit is cylindrical.

18. The method according to claim 16, wherein the sleeve has an at least predominantly circular cross section before the energy storage unit is introduced.

19. The method according to claim 16, wherein the energy storage unit is radially compressed.

20. The method according to claim 16, wherein the layers are circular or spiral in cross section.

21. The method according to claim 16,
wherein a projection or a plurality of projections is formed in the sleeve, and the circumference is reduced by compressing the projection or the plurality of projections.

22. The method according to claim 21, wherein the projection or the plurality of projections projects radially outward.

23. The method according to claim 21, wherein the projection or the plurality of projections is compressed along the circumference.

24. The method according to claim 21, wherein the sleeve is formed entirely or partially from a plastically deformable material.

25. The method according to claim 16,
wherein the sleeve is provided with an axially extending interruption;
wherein a first free end and a second free end are situated opposite each other at the axially extending interruption; and
wherein the circumference is reduced by fastening the first free end and the second free end to each other.

26. The method according to claim 25, wherein an overlap between the first free end and the second free end is created before the fastening operation.

27. The method according to claim 25, wherein the fastening is created by welding.

28. The method according to claim 25, wherein the sleeve is formed entirely or partially from an elastic material.

29. The method according to claim 16, wherein the energy storage unit has a solid core around which the layers are wound.

30. An electrochemical solid state energy storage cell that has been produced using the method according to claim 16.

31. The storage cell according to claim 30, wherein the layers comprise electrodes and separators.
